(19) United States
(12) Patent Application Publication
(10) Pub. No.: US 2026/0135403 A1
(43) Pub. Date: May 14, 2026

(54) OPERATING A POWER TOOL FOR A DESIRED RUNTIME

(71) Applicant: MILWAUKEE ELECTRIC TOOL CORPORATION, Brookfield, WI (US)

(72) Inventors: Daniel W. Medeiros, Brookfield, WI (US); Andrew McCartney, Libertyville, IL (US)

(21) Appl. No.: 19/382,594

(22) Filed: Nov. 7, 2025

Related U.S. Application Data
(60) Provisional application No. 63/718,359, filed on Nov. 8, 2024.

(51) Int. Cl. H02J 7/00; H01M 10/42; H01M 10/48; H01M 50/247

(52) U.S. Cl. CPC H02J 7/855; H01M 10/425; H01M 10/486; H01M 50/247; H01M 2010/4271; H01M 2220/30

(57) ABSTRACT

A power tool and a method of operating the power tool to achieve a desired runtime are disclosed. The power tool includes a controller configured to determine at least one parameter of a connected battery pack. Based on the parameter, the controller is further configured to calculate an available capacity in ampere-hours. The controller receives a runtime mode corresponding to a desired runtime and calculates a required current draw based on the available capacity and the selected runtime mode. The power tool operates by drawing the calculated current to achieve the desired runtime. The controller is also configured to determine when the power tool has operated for the desired runtime and to cease operation in response.

### RELATED APPLICATIONS

This application claims priority to U.S. Provisional Patent Application No. 63/718,359, filed Nov. 8, 2024, the entire content of which is incorporated herein by reference.

### FIELD

The present disclosure relates to battery packs and specifically to adapting power of a battery pack for powering power tools.

### BACKGROUND

Air moving power tools, e.g., vacuums, blowers, and fans, include settings to control the power at which the motors run. For example, a blower may include a high-power setting which runs for a short time period compared to a long time period for a low-power setting. While this gives a user some control on extending runtimes, the short time period and long time period are arbitrary and do not guarantee the user will meet a runtime target.

### SUMMARY

As will be described in more detail, aspects of the disclosure herein are directed toward a control system for a power tool that allows a user to select a desired runtime for the power tool. The controller enables automatic adjustment to internal operating parameters for the air moving power tool in order to achieve the desired runtime. The adjustments are based on a state of charge and state of health for the battery along with other power tool parameters.

Before any aspects of the disclosure are explained in detail, it is to be understood that the disclosure is not limited in application to the details of the configuration and arrangement of components set forth in the following description or illustrated in the accompanying drawings. Aspects of the disclosure are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Power tool battery packs are used at worksites to operate various power tools. Setting a predetermined runtime for a power tool enables a user to finish a job without having to change the battery pack.

The present disclosure relates to, in one aspect, a battery pack for powering an air moving tool, the air moving tool comprising a motor and a controller for controlling an amount of power provided to the motor from the battery pack over the course of a predetermined time.

In some aspects, the techniques described herein relate to a method of operating a power tool for a desired runtime, the method including: determining, with a controller for the power tool, at least one parameter of a battery pack connected to the power tool; generating, with the controller, an available capacity in ampere-hours based on the at least one parameter; receiving, at the controller, a runtime mode associated with a desired runtime; calculating, with the controller, a required current draw based on the available capacity and the runtime mode to achieve the desired runtime; drawing an amount of current equal to the calculated required current draw to operate the power tool; determining that the power tool has operated for the desired runtime; and ceasing operation of the power tool in response to determining that the power tool has operated for the desired runtime.

In some aspects, the techniques described herein relate to a method, further including collecting, with a set of sensors in communication with the controller, a set of variables, including a voltage and a current of the battery pack.

In some aspects, the techniques described herein relate to a method, further including determining, with the set of sensors, a battery temperature of the battery pack.

In some aspects, the techniques described herein relate to a method, further including predicting, with a pack thermal model (PTM) of the controller, a battery temperature of the battery pack.

In some aspects, the techniques described herein relate to a method, wherein determining the at least one parameter of the battery pack further includes calculating, at the controller, a state of charge (SoC) of the battery pack using a machine learning algorithm.

In some aspects, the techniques described herein relate to a method, further including determining a pack ID of the battery pack based on the determined at least one parameter using a machine learning algorithm.

In some aspects, the techniques described herein relate to a method, further including receiving, at the controller, one or more updated parameters of the battery pack and recalculating, with the controller, the current draw required to achieve the desired runtime based on the updated parameters of the battery pack.

In some aspects, the techniques described herein relate to a method, further including updating operation of the power tool to operate at the recalculated current draw.

In some aspects, the techniques described herein relate to a method, wherein estimating the at least one parameter includes at least one selected from a list consisting of: a state of charge (SoC), a state of health (SoH), or a battery impedance (DCIR).

In some aspects, the techniques described herein relate to a method, wherein the at least one parameter is provided by a battery pack controller of the battery pack.

In some aspects, the techniques described herein relate to a method, further including operating a motor to draw the amount of current equal to the calculated required current drawn to operate the power tool.

In some aspects, the techniques described herein relate to a power tool, including: a set of sensors configured to measure a set of variables associated with a battery pack coupled to the power tool, wherein the set of variables includes a current or a voltage of the battery pack; a human machine interface configured to generate a runtime mode output, wherein the runtime mode output indicates a desired runtime of the power tool; and a controller configured to determine at least one operating parameter for the battery pack based on the set of variables and adapt an amount of current drawn from the battery pack based on the desired runtime and the at least one operating parameter.

In some aspects, the techniques described herein relate to a power tool, further including a motor.

In some aspects, the techniques described herein relate to a power tool, wherein the set of variables further includes a battery temperature of the battery pack.

In some aspects, the techniques described herein relate to a power tool, wherein the controller includes a pack thermal model (PTM) configured to determine a battery temperature of the battery pack based on a mathematical model.

In some aspects, the techniques described herein relate to a power tool, wherein the at least one operating parameter includes at least one selected from a list consisting of: a state of charge (SoC), a state of health (SoH), or a battery impedance (DCIR).

In some aspects, the techniques described herein relate to a power tool, the controller is configured to determine a pack ID of the battery pack.

In some aspects, the techniques described herein relate to a power tool including: a battery pack interface for engaging with a battery pack to power the power tool; a set of sensors for measuring a set of variables associated with the battery pack; and a controller, the controller configured to: determine a state of charge of the battery pack based on the set of variables; generate an available capacity in ampere-hours based on the state of charge; receive a selected runtime mode associated with a desired runtime mode indicating a desired runtime; calculate a required current draw in amperes based on the available capacity and the selected runtime mode; and operate the power tool to draw an amount of current equal to the required current draw to achieve the desired runtime.

In some aspects, the techniques described herein relate to a power tool, wherein the controller is configured to determine a state of health (SoH) or a battery impedance (DCIR) associated with the battery pack and based on the set of variables.

In some aspects, the techniques described herein relate to a power tool, wherein the controller includes a pack thermal model (PTM) configured to determine a battery temperature of the battery pack based on a mathematical model.

Other independent aspects of the disclosure will become apparent by consideration of the detailed description and accompanying drawings.

### BRIEF DESCRIPTION OF THE DRAWINGS

FIG. 1 is a block diagram illustrating a battery pack and a power tool.

FIG. 2 is a perspective view of a vacuum assembly.

FIG. 3 is a schematic cross-sectional view of the vacuum assembly of FIG. 2.

FIGS. 4A and 4B illustrate a block diagram of the vacuum assembly of FIG. 1.

FIG. 5 is a schematic illustrating a control system for the battery pack and the power tool of FIG. 1 according to one aspect of the disclosure herein.

FIG. 6 is a schematic flow diagram for a control system with a battery pack and the power tool according to another aspect of the disclosure herein.

FIG. 7 is a flowchart illustrating a process for implementing a desired runtime for the power tool with the battery pack of FIG. 6.

FIG. 8 is a schematic flow diagram for a control system with a battery pack and the power tool according to yet another aspect of the disclosure herein.

FIG. 9 is a flowchart illustrating a process for implementing a desired runtime for the power tool with the battery pack of FIG. 8.

### DETAILED DESCRIPTION

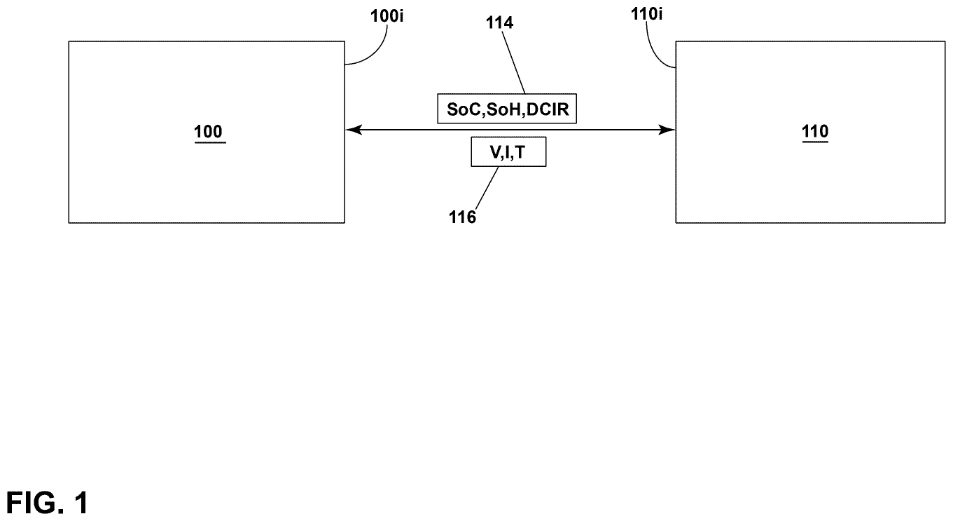

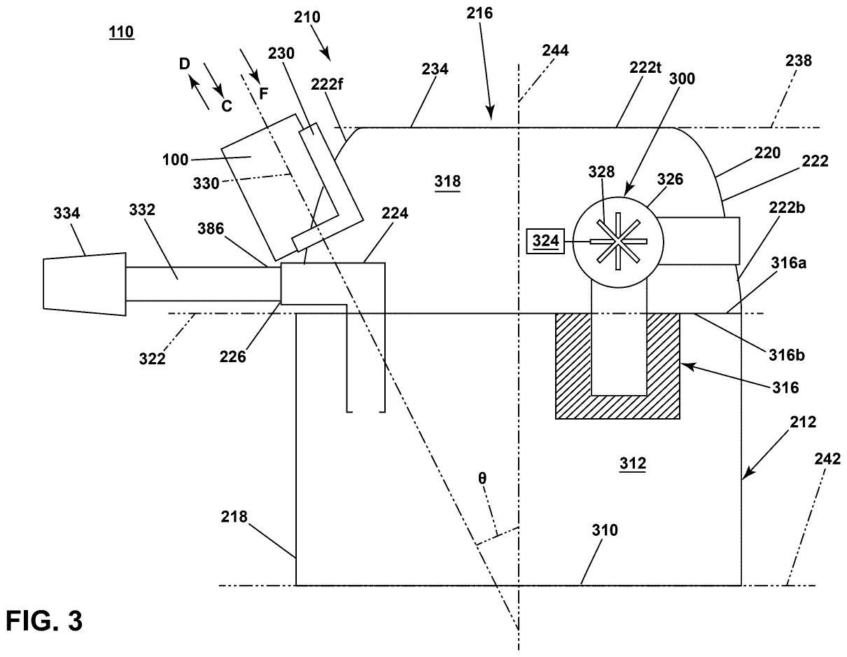

FIG. 1 is a schematic illustrating a battery pack 100 and a power tool 110. The power tool 110 may be an air moving power tool, e.g., a blower, fan, or vacuum. The power tool 110 may include a motor 324 (FIG. 3) for providing power to the power tool 110 when the battery pack 100 is engaged with the power tool 110. In other implementations the power tool 110 is non-motorized, e.g., a work light, site light, or search light. The battery pack 100 includes a battery interface 100i for engagement with the power tool 110. The power tool 110 includes a corresponding power tool interface 110i for engagement with the battery pack 100. The interfaces 100i, 110i may be any suitable interfaces for electrically connecting the battery pack 100 to the power tool 110, including, for example corresponding sliding interfaces or a pocket interface with a corresponding insertable interface.

Other types of power tools contemplated include, by way of example, motorized power tools (e.g., a cut-off saw, a miter saw, a table saw, a core drill, an auger, a breaker, a demolition hammer, a compactor, a vibrator, a compressor, a drain cleaner, a welder, a cable tugger, a pump, etc.), outdoor tools (e.g., a chain saw, a string trimmer, a hedge trimmer, a blower, a lawn mower, etc.), other motorized devices (e.g., vehicles, utility carts, a material handling cart, etc.), and non-motorized electrical devices (e.g., a power supply, a light, an AC/DC adapter, a generator, etc.).

When engaged with each other, the battery pack 100 and the power tool 110 can exchange information related to operating parameters of the battery pack 100. Operating parameters 114 may include, but are not limited to, a state of charge (“SoC”), a state of health (“SoH”), a battery impedance or a direct current internal resistance (“DCIR”), and/or other operating parameters as required for a given application. The battery pack 100 and power tool 110 can also exchange information regarding a set of variables 116 associated with internal measurements of the battery pack 100, including but not limited, a battery current (“I”), a battery voltage (“V”), a battery temperature (“T”), and/or other battery measurements as required for a given application.

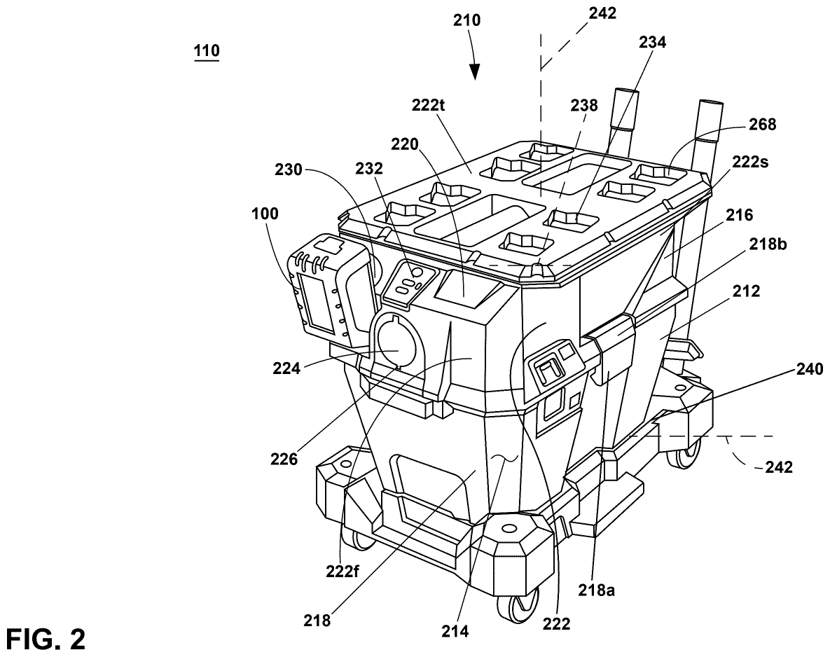

FIG. 2 illustrates a vacuum assembly 210 according to one example of the power tool 110 from FIG. 1. The vacuum assembly 210 is a form of a wet/dry vacuum assembly including a collection vessel or container 212 having a body 214 defining a collection volume 312 (FIG. 3) therein. A power head 216 may be removably couplable to the collection container 212 via a first coupling element 218a configured to form a releasable connection with a corresponding second coupling element 218b of either the power head 216 or an intermediate stack accessory. More specifically, the container 212 includes a lip formed into the body 214 thereof to which a latch may releasably engage. While the illustrated coupling elements 218a, 218b are a lip and a corresponding latch to be used together, it is understood that in other implementations the positions may be reversed. In still other implementations, other forms of connection (e.g., latches, clamps, clips, and the like) may be used.

The power head 216 includes a head housing 220 at least partially enclosing a power head volume 318 (FIG. 3) therein. A series of walls or plates 222 at least partially define the head housing 220. More specifically, the head housing 220 includes a face plate or front wall 222f, a top plate 222t, a back plate 222b (FIG. 3), and a pair of side walls 222s. An inlet passage 224 may extend between and be open to an exterior of the head housing 220 and the collection volume 312 (FIG. 3) of the vacuum assembly 210 when the power head 216 is attached to the container 212. The front wall 222f may include an inlet 226 open to the inlet passage 224. Additionally, the front wall 222f may include one or more battery terminals 230 and a user interface panel 232. The user interface panel 232 generally includes one or more user inputs (i.e., buttons, displays, touch screens, and the like) to operate the vacuum assembly 210.

The top plate 222t of the power head 216 may be formed to include a docking interface 234 configured to allow one or more accessories (e.g., storage containers, tools, bags, pouches, organizers, and the like) to be releasably attached thereto. More specifically, the illustrated docking interface 234 includes a plurality of individual connection elements or points 236, each formed into or otherwise attached to the top plate 222t. The connection points 236 are each able to form a releasable connection with a corresponding accessory. In the illustrated implementation, the top plate 222t is substantially planar and defines a top plane 238. The vacuum assembly 210 includes a support surface 240 defining a support plane 242 that is parallel to the support surface upon 240 upon which the vacuum assembly 210 rests during operation. In the illustrated implementation, the top plane 238 is parallel to the support plane 242. A stack axis 244 extends normal to the top plane 238 and the support plane 242.

FIG. 3 is a schematic cross-sectional view of the vacuum assembly 210 from FIG. 2 illustrating a blower assembly 300 disposed therein. The body 214 of the container 212 includes a base wall 310 and the plurality of side walls 218 that extend from a periphery of the base wall 310 to define the collection volume 312. The body 214 is open at an open end 314 opposite of the base wall 310. The open end 314 provides access to the collection volume 312. At least a portion of the blower assembly 300 extends into the collection volume 312. The base wall 310 may be generally octagonal in shape where eight side walls 218 extend upwardly therefrom. However, in other implementations, different shaped containers may be present. In the illustrated implementation, the base wall 310 is parallel to the support plane 242.

The open end 314 of the container 212 may include a first connection interface 316a to which other devices may be releasably attached (e.g., the power head 216 or other intermediate stack accessories). During use, the first connection interface 316a serves to physically align the connected elements (e.g., vertically, horizontally, and rotationally) while also establishing an internal connection region. The internal connection region, in turn, serves as an area where various operable connections (e.g., airflow passage connections, electrical connections, debris passage connections, and the like) may be made and the transfer of material (e.g., air, dust, debris, and the like) may occur within the confines of the assembled vacuum's structure.

The blower assembly 300 is at least partially positioned within the power head volume 318 of the head housing 220. The power head volume 318 is at least partially defined by a bottom or base wall 320 defining a base wall plane 322 generally parallel thereto. The base wall plane 322 is parallel to the support plane 242 when the power head 216 is attached to the container 212. The back plate 222b, or back wall, extending from the base wall 320 opposite the front wall 222f.

The base wall 320 of the power head 216 may include a second connection interface 316b to which other devices may be releasably attached (e.g., the container 212 or other intermediate stack accessories). During use, the second connection interface 316b serves to physically align the connected elements (e.g., vertically, horizontally, and rotationally) while also establishing an internal connection region 316. The internal connection region, in turn, serves as an area where various operable connections (e.g., airflow passage connections, electrical connections, debris passage connections, and the like) may be made and the transfer of material (e.g., air, dust, debris, and the like) may occur within the confines of the assembled vacuum's structure.

The blower assembly 300 may include a motor 324, a volute 326, and an impeller 328 positioned within the volute 226 and rotatable with respect thereto. During use, electrical power is provided to the motor 324 which, in turn, rotates the impeller 328 relative to the volute 326 generating airflow within the vacuum assembly 210. A primary power source (e.g., a battery pack 100) provides electrical power to energize the motor 324. The motor 324 is energized based on a selection of the power button and, optionally, one or modes or settings selected by the user or automatically determined by the controller as described in further detail below.

In the illustrated implementation, a battery introduction axis 330 is oriented such that it forms a first angle θ relative to the stack axis 244. More specifically, the battery introduction axis 330 is oriented (i.e., the first angle θ is sized) so that it is sufficiently angled to allow the user to readily read the battery level indicator on the battery pack 100 when installed on the terminal 420, but also sufficiently vertical so that the vacuum assembly 210 does not roll or otherwise move due to the docking force F applied to the battery pack 100 when being installed in the terminal 420. More specifically, in some implementations the first angle θ is approximately 5 degrees, 10 degrees, 15 degrees, and 20 degrees (+1%, +2%, +5%, +10%). In still other implementations, the first angle 256 is between 1 degree and 10 degrees, between 2 degrees and 10 degrees, between 5 degrees and 10 degrees, between 5 degrees and 15 degrees, between 5 degrees and 20 degrees, between 1 degree and 15 degrees, between 5 degrees and 15 degrees, and between 5 degrees and 20 degrees.

The vacuum assembly 210 may also include a vacuum hose 332 that may be releasably coupled to the inlet 226 of the inlet passage 224. Specifically, the vacuum hose 332 is an elongated element having a first end θ removably couplable to the inlet 226 and a second or distal end 334 opposite the first end θ. In some implementations, all or a portion of the hose 332 may be flexible. In other implementations, all or a portion of the hose 332 may be rigid. In still other implementations, the hose 332 may be formed as a single piece or include a plurality of individual sub-segments that can be combined in various combinations to produce the desired hose configuration.

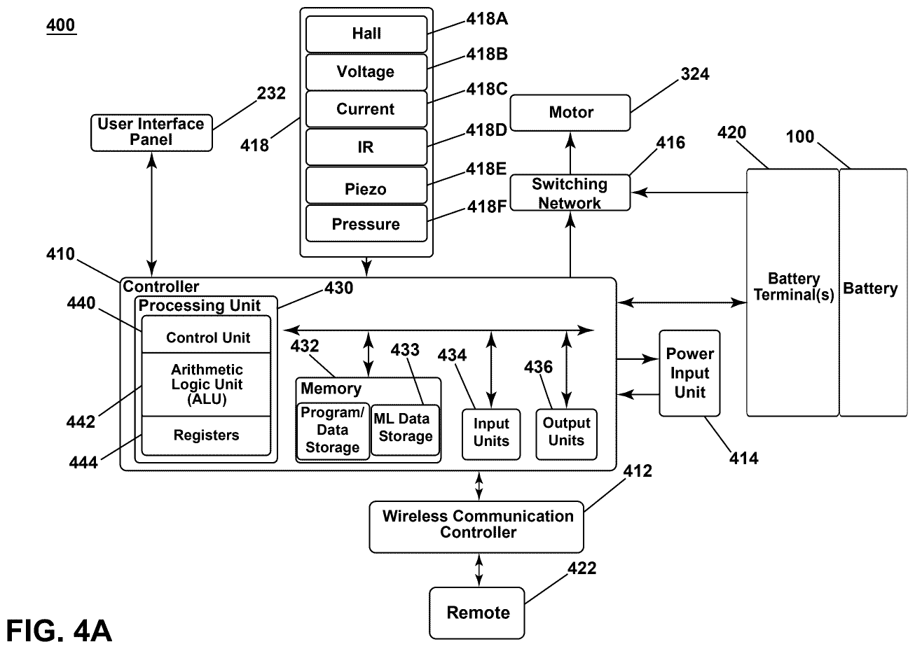

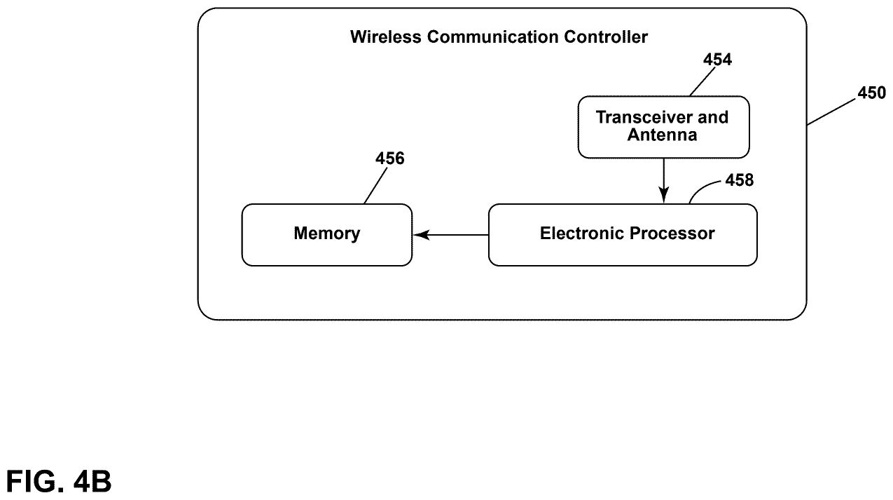

FIG. 4A illustrates control system 400 for the vacuum assembly 210 according to one example. The control system 400 includes a controller 410, a wireless communication controller 412, a power input unit 414, a switching network 416, sensors 418, the user interface panel 232, and a set of battery terminals 420. The set of battery terminals 420 are coupled to the controller 410 and couples to the battery pack 100. The set of battery terminals 420 transmit power received from the battery pack 100 to the power input unit 414. The power input unit 414 includes active and/or passive components (e.g., voltage step-down controllers, voltage converters, rectifiers, filters, etc.) to regulate or control the power received through the set of battery terminals 420 and to the wireless communication controller 412 and the controller 410.

The switching network 416 enables the controller 410 to control the operation of the motor 324. Generally, when the vacuum assembly 210 is turned on, electrical current is supplied from the set of battery terminals 420 to the motor 324, via the switching network 416.

In response to the controller 410 receiving a power on signal from the user interface panel 232 or a remote 422, the controller 410 activates the switching network 416 to provide power to the motor 324. In some implementations, the switching network 416 controls the amount of current available to the motor 324 and thereby controls the speed and torque output of the motor 324. The switching network 416 may include numerous field-effect transistors (“FETs”), bipolar transistors, or other types of electrical switches. For instance, the switching network 416 may include a six-FET bridge that receives pulse-width modulated (“PWM”) signals from the controller 410 to drive the motor 324. In some implementations, the switching network 416 controls power consumption of the vacuum assembly 210 (the current and voltage supplied to the motor 324) based on one or more modes or settings selected by a user via the user interface panel 232, the remote 422, or both. In some implementations, the switching network 416 controls the current and voltage supplied to the motor 380 based on usage of the vacuum assembly 210 (whether or not the vacuum assembly 210 is idle).

The sensors 418 are coupled to the controller 410 and communicate to the controller 410 various signals indicative of different parameters of the vacuum assembly 210. The sensors 418 include one or more Hall effect sensors 418A, one or more voltage sensors 418B, one or more current sensors 418C, one or more infrared (IR) sensors 418D, one or more Piezo sensors 418E, one or more pressure sensors 418F, and/or sensors as required for a given application. Each Hall effect sensor 418A outputs motor feedback information to the controller 410, such as an indication (e.g., a pulse) when a magnet of a rotor of the motor 324 rotates across the face of that Hall effect sensor. Based on the motor feedback information from the Hall effect sensors 418A, the controller 410 can determine the position, velocity, and acceleration of the rotor. In response to the motor feedback information and one or more signals, such as a desired mode of the vacuum assembly 210 (for example, whether the vacuum assembly 210 is in low power mode or high-power mode), the controller 410 transmits control signals to control the switching network 416 to drive the motor 380. For instance, by selectively enabling and disabling the FETs of the switching network 416, power received via the battery terminals 420 is selectively applied to stator coils of the motor 380 to cause rotation of its rotor. The current and voltage information is used by the controller 410 determine power being supplied by the battery pack 100 and ensure proper timing of control signals to the switching network 416.

In some implementations, the user interface panel 232 and/or remote 422 receives control signals from the controller 410 to convey information based on different states or modes of the vacuum assembly 210. For example, the user interface panel 232 includes indicators such as one or more light-emitting diodes (“LEDs”), or a display screen and can be configured to display conditions of, or information associated with, the vacuum assembly 210. For example, the indicators may be configured to indicate measured electrical characteristics of the vacuum assembly 210, the status of the vacuum assembly 210, the mode of the vacuum assembly 210, etc. In some implementations, this information may be conveyed to a user through audible or tactile outputs.

As described above, the controller 410 is electrically and/or communicatively connected to a variety of modules or components of the vacuum assembly 210. In some implementations, the controller 410 includes a plurality of electrical and electronic components that provide power, operational control, and protection to the components and modules within the controller 410 and/or vacuum assembly 210. For example, the controller 410 includes, among other things, a processing unit 430 (e.g., a microprocessor, a microcontroller, electronic processor, electronic controller, or another suitable programmable device), a memory 432, input units 434, and output units 436. The processing unit 430 (herein, electronic processor 430) includes, among other things, a control unit 440, an arithmetic logic unit (“ALU”) 442, and a plurality of registers 444. In some implementations, the controller 410 is implemented partially or entirely on a semiconductor (e.g., a field-programmable gate array [“FPGA”] semiconductor) chip, such as a chip developed through a register transfer level (“RTL”) design process.

The memory 432 includes, for example, a program/data storage area and a machine learning data storage area 433. The program storage area and the data storage area can include combinations of different types of memory, such as a read-only memory (“ROM”), a random access memory (“RAM”) (e.g., dynamic RAM [“DRAM”], a synchronous DRAM [“SDRAM”], etc.), an electrically erasable programmable read-only memory (“EEPROM”), a flash memory, a hard disk, a secure digital (“SD”) card, or other suitable magnetic, optical, physical, or electronic memory device(s). The electronic processor 430 is connected to the memory 432 and executes software instructions that are stored in a memory 432 (e.g., RAM during execution), a ROM (e.g., on a generally permanent basis), or another non-transitory computer readable medium such as another memory or a disc). Software included in the implementation of the vacuum assembly 210 can be stored in the memory 432 of the controller 410 (e.g., in the program storage area). The software includes, for example, firmware, one or more applications, program data, filters, rules, one or more program modules, and other executable instructions. The controller 410 is configured to retrieve from memory and execute, among other things, instructions related to the control processes and methods described herein. The controller 410 is also configured to store vacuum information on the memory 432 including operational data, information identifying the type of vacuum, a unique identifier for the particular vacuum, and other information relevant to operating or maintaining the vacuum assembly 210. The vacuum usage information, such as current levels, motor speed, motor acceleration, whether the vacuum is actively vacuuming, may be captured or inferred from data output by the sensor(s) 418. Such information may then be accessed with the external electronic device. In other constructions, the controller 410 includes additional, fewer, or different components.

The memory 432 stores various identifying information of the vacuum assembly 210 including a unique binary identifier (UBID), an American Standard Code for Information Interchange [“ASCII”] serial number, an ASCII nickname, and a decimal catalog number. The UBID both uniquely identifies the type of vacuum and provides a unique serial number for each vacuum assembly 210. Additional or alternative techniques for uniquely identifying the vacuum assembly 210 are used in some implementations.

FIG. 4B illustrates a schematic of the wireless communication controller 412 according to one example. The wireless communication controller 412 includes a radio transceiver and an antenna 454, a memory 456, and an electronic processor 458. The radio transceiver and antenna 454 operate together to send and receive wireless messages to and from the remote 422 and the electronic processor 458. The memory 456 can store instructions to be implemented by the electronic processor 458 and/or may store data related to communications between the vacuum assembly 210 and the remote 422 or the like. The electronic processor 458 for the wireless communication controller 450 controls wireless communications between the vacuum assembly 210 and the remote 470. For example, the electronic processor 458 associated with the wireless communication controller 450 buffers incoming and/or outgoing data, communicates with the controller 410, and determines the communication protocol and/or settings to use in wireless communications.

In the illustrated implementation, the wireless communication controller 450 is a Bluetooth® controller. The Bluetooth® controller communicates with the remote 470 employing the Bluetooth® protocol. Therefore, in the illustrated implementation, the remote 470 and the vacuum assembly 210 are within a communication range (i.e., in proximity) of each other while they exchange data. In other implementations, the wireless communication controller 450 communicates using other protocols (e.g., Wi-Fi®, cellular protocols, a proprietary protocol, etc.) over a different type of wireless network. For example, the wireless communication controller 450 may be configured to communicate via Wi-Fi® through a WAN, such as the Internet or a LAN, or to communicate through a piconet (e.g., using infrared or near-field communications (“NFC”).

The wireless communication controller 412 is configured to receive data from the controller 410 and relay the information to the remote 422 via the transceiver and antenna 454. In a similar manner, the wireless communication controller 412 is configured to receive information from the remote 422 via the transceiver and antenna 454 and relay the information to the controller 410.

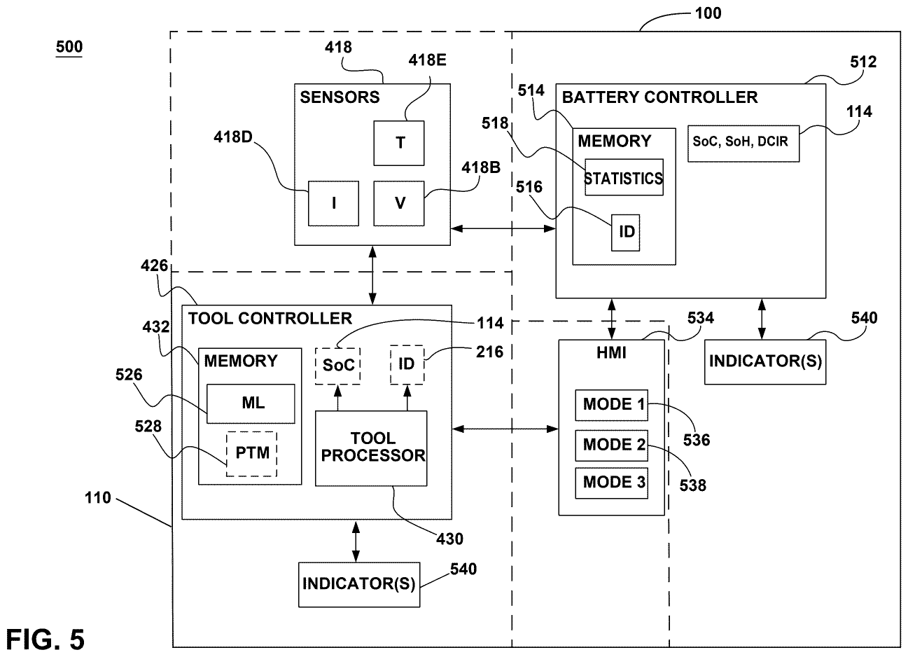

FIG. 5 is a schematic illustrating a control system 500 for the battery pack 100 and the power tool 110 illustrated in FIGS. 1, 2, and 3 according to one example. The battery pack 100 includes a battery controller 512 (e.g., part of a Battery Management System “BMS”). The battery controller 512 includes a battery memory 514 for storing, by way of example a battery pack ID 516 and charge/discharge statistics 518 associated with the battery pack 100. The battery controller 512 is configured to estimate at least one operating parameter 114 of the battery back 100.

The battery pack ID 516 may be defined by a nominal voltage, a current capacity, a connection configuration (e.g., “tower” vs. “slide-on”), etc., of the battery pack 100. For example, the battery pack ID 516 may identify a high-power battery pack with a nominal voltage of about 12V and having a tower-style configuration. In another example, the battery pack ID 516 may identify a high-power battery pack with a nominal voltage of 18V and a slide-on configuration. The charge/discharge statistics 518 may include information regarding life span of the battery, previous charging information, compatible power tools, or the like.

The power tool 110 includes a tool controller, by way of example the controller 410 described herein. A Machine learning (“ML”) module 526 and a pack thermal model (PTM) 528 may be stored in the memory 432. The ML module 526 may include programming for predicting or calculating information regarding a runtime for the power tool 110 based on the operating parameters 114 of the battery back 100. In one aspect the PTM 528 determines the temperature of the battery pack 100. In one aspect, the processor 430 is configured to estimate at least one of the operating parameters 114 (e.g., the SoC) and the pack ID 516 of the battery back 100.

One or more of the sensors 418 may be integral with the battery pack 100 for providing measurements associated with the operating parameters 114. For example, to determine the state of charge (SoC) of the battery pack 100 the voltage sensor 418B, the current sensor 418D, and the temperature sensor 418E may be utilized. In one example, temperature sensor 418E is a thermistor or a digital temperature sensor integral with the battery pack 100 for measuring the battery temperature T. In one example, the current sensor 418D is a shunt resistor and an analog to digital converter (ADC) integral with the battery pack 100 for measuring the battery current I. In one example, the voltage sensors 418B is a voltage divider combined with the ADC or a battery monitor integrated circuit (IC) integral with the battery pack 100 for measuring the battery voltage V.

Additionally, one or more of the sensors 418 may be integral with the power tool 110. In one example the Hall effect sensor 418A measures current flow between the battery pack 100 and the power tool 110, and in turn contributes to determining the SoC of the battery pack 100.

The sensors 418 may be utilized separately or in combination to determine other operating parameters 114 including the state of health (SoH) and the battery impedance (DCIR). For example, to determine the SoH and/or the DCIR measurements from the voltage sensor 418B, the current sensor 418D, and the temperature sensor 418E may be utilized.

The control system 500 includes a Human Machine Interface (“HMI”) 534 for controlling an amount of power provided to the power tool 110, by way of example to the motor 324 for controlling a speed of the motor 324. In other implementations the HMI 534 provides various current draw amounts in relation to lighting (e.g., to adjust brightness) where the power tool 110 is a site light or LEDs are integrated into the power tool 110. The HMI 534 may be the user interface panel 264 described above. It is also contemplated that the HMI 534 is a separate wireless HMI, such as on a smart device, (e.g., the remote 422, a smart phone, tablet computer, and/or other devices as required for a given application), that is in electronic communication with the power tool 110, such as via the wireless communication controller 450. In one embodiment, the HMI may be a smart device equipped with One-Key® from Milwaukee Electric Tool®. A set of inputs 536 are used to select different runtime modes 538, illustrated by way of example as three modes, for the power tool 110. By way of example, Mode 1 may be associated with a desired runtime of 15 minutes, mode 2 may be associated with a desired runtime of 30 minutes, and mode 3 may be associated with a desired runtime of 1 hour. The set of inputs 536 may be buttons on the HMI 534 as illustrated. It is also contemplated that the set of inputs 536 may be integral with the power tool 110 and the HMI 534.

The control system 500 includes indicator(s) 540, for example LEDs, that light up to indicate that the power tool 110 is on, that the battery pack 100 is engaged with the power tool 110, that the battery pack 100 is charged, or that the battery pack 100 is in need of a charge, and the like. As illustrated the indicator(s) 540 may be separate indicator(s) dedicated to the battery pack 100 and to the power tool 110 respectfully.

In one example, after a user selects one of the runtime modes 538 associated with a desired runtime via the set of inputs 536, the electronic processor 430 will calculate an amount of current to be drawn from the battery pack 100 to achieve the desired runtime. These calculations are based on the operating parameters 114 (e.g., SoC, SoH, and DCIR) and the selected runtime mode 538. The electronic processor 430 may use a combination of one or more operating parameters 114 of the battery pack 100 to determine how much power is required to meet the selected runtime mode. In other words, an amount of current drawn from the battery pack 100 is adapted based on the available operating parameters 114 in order for the power tool 110 to operate for the desired runtime. The calculations may be performed in a variety of ways described in more detail herein.

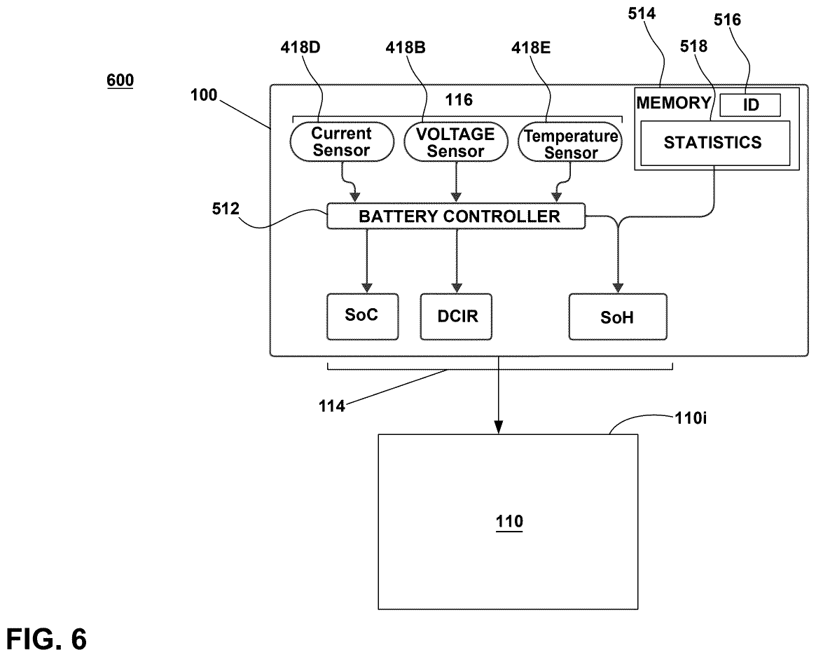

FIG. 6 is a schematic flow diagram 600 for control of the battery pack 100 and the power tool 110 according to an example. The sensors 418 measure and distribute the set of variables 116 (e.g., the battery temperature T, the battery current I, and the battery voltage V). The set of variables 116 is provided to the battery controller 212 to determine the operating parameters 114. The battery controller 512 is configured to estimate the SoC and the DCIR of the battery back 100 based on the set of variables 116. The battery controller 212 also receives the pack ID 516 and the charge/discharge statistics 518 from the memory 514. The battery controller 212 is configured to estimate the SoH of the battery pack 100 based on the set of variables 116 and the charge/discharge statistics 518. The operating parameters 114 are sent to the power tool 110 for determining the amount of current drawn for meeting the desired runtime.

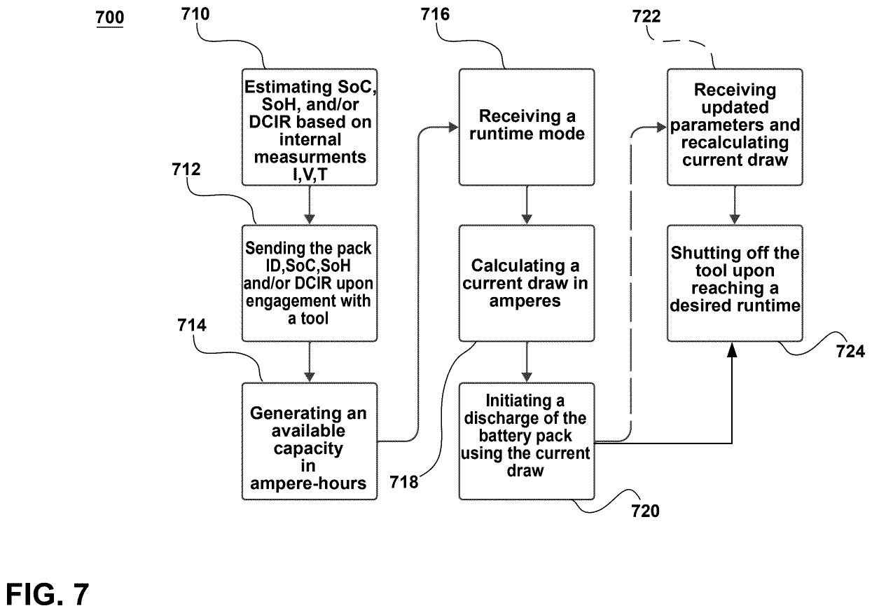

FIG. 7 illustrates a flow diagram for a method 700 of implementing a desired runtime operation for the power tool 110 with the battery pack 100 of FIG. 7. The method 700 may be carried out by the battery controller 212 and/or the controller 410.

At process block 710, the battery controller 212 estimates at least one of the operating parameters 114 based on the battery current I, the battery voltage V, the battery temperature T, and/or the charge/discharge statistics 518. In one example, using the processing unit 430, the battery controller 212 estimates the SoC and the DCIR based on the set of variables 116 and the SoH based on the set of variables 116 and the charge/discharge statistics 518 and utilizing Equation 1, Equation 2, and Equation 3.

$$Impedence ( DCIR ) = \frac{Δ V}{Δ I} \qquad EQUATION ( 1 )$$

$$SoC ( t ) = SoC ( {t}_{0} ) + \frac{1}{{C}_{rated}} {\int }_{{t}_{0}}^{t} I ( τ ) d τ \qquad EQUATION ( 2 )$$

$$SoH ( \% ) = \frac{{DCIR}_{actual} ( Ω )}{{DCIR}_{rated} ( Ω )} \qquad EQUATION ( 3 )$$

At process block 712, upon engagement between the battery pack 100 and the power tool 110, the battery controller 512 sends a signal to the controller 410 associated with the pack ID 516 and at least one of the operating parameters 114. In one example, the signal sent includes all of the operating parameters 114.

At process block 714, the controller 410, via the processing unit 430, generates an available capacity in ampere-hours (Ah). The controller 410 may utilize all or one of the received pack ID 516 and the operating parameters 114 to generate the available capacity utilizing Equation 4 or Equation 5.

$$Capacity ( Ah ) = ( \frac{SoC}{100} ) \times {C}_{rated} \qquad EQUATION ( 4 )$$

$$Capacity ( Ah ) = ( \frac{SoH}{100} ) \times ( \frac{SoC}{100} ) \times {C}_{rated} \qquad EQUATION ( 5 )$$

At process block 716, the controller 410 receives, via the set of inputs 536, the runtime mode 538 associated with the desired runtime. For example, a user may select mode 2 which is associated with a desired runtime of 30 minutes.

At process block 718, the controller 410, via the processor 430, calculates a current draw in amperes (A) based on the available capacity (from Equation 4 or Equation 5) and the requested runtime mode 538 to achieve the desired runtime using Equation 6.

$$I ( A ) = \frac{Capacity}{t} \qquad EQUATION ( 6 )$$

At process block 720, the controller 410 initiates discharge of the battery pack 100 using the calculated current draw to operate the power tool 110. In some embodiments, the controller 410 controls the power tool 110 based on the calculated current draw to facilitate operating for the desired runtime.

The controller 410 may track an amount of runtime based solely on the initial parameter readings as described above. It is further contemplated that at block 722 the controller periodically queries the battery pack 100 for updated operating parameters 114 and the battery controller 512 recalculates the required current draw to ensure that the power tool 110 will meet the desired runtime. The power of the power tool 110 may vary as the current does. For example, in response to determining that the required current draw is less than the initial current draw, the controller 410 may reduce the output power of the motor 324 to control the current draw. Similarly, in response to determining that the required current draw is greater than the initial current draw, the controller 410 may increase the output power of the motor 324 to control the current draw.

At process block 724, the controller 410 ceases operation of the power tool, thereby stopping the current draw from the battery pack 100 to the power tool 110, to stop operation of the power tool 110 upon reaching the desired runtime.

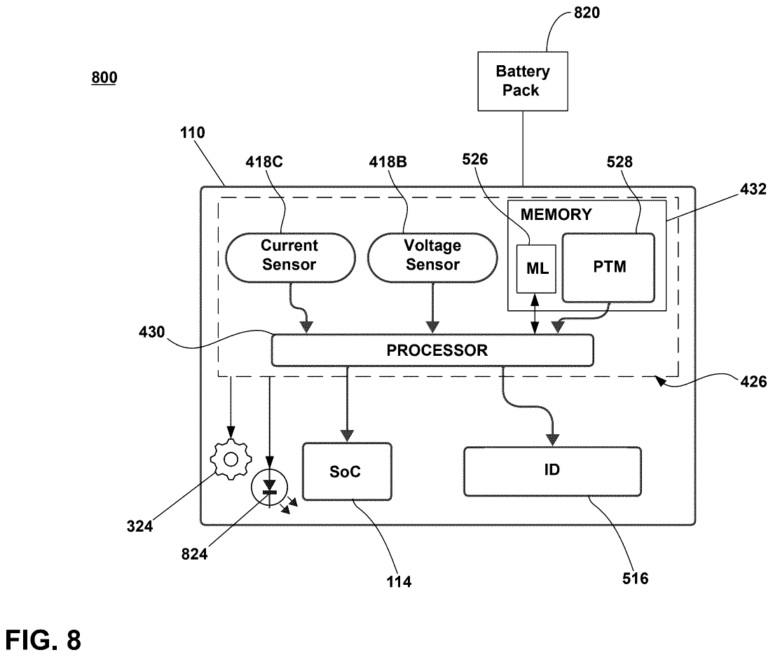

FIG. 8 is a schematic flow diagram 800 for a control of a battery pack 820 and the power tool 110 according to an aspect of the disclosure herein. The battery pack 820 may be similar to the battery pack 100 already described herein; however, the battery pack 820 may be configured to only provide power (i.e., current and voltage) to the power tool 110, but no additional data (e.g., SoH, SoC, DCIR, etc.) to the power tool 110. In this example, it is contemplated that the battery pack 820 includes only the basics required for the battery pack 820 to provide power to the power tool 110.

As described previously herein, the power tool 110 includes the current sensor 418C and the voltage sensor 418B of the sensors 418 for collecting the set of variables 116 including the battery current (“I”) and the battery voltage (“V”). The pack thermal model (PTM) 528 is configured to determine the battery temperature T. In one embodiment, the controller 410 in conjunction with the PTM 528 may determine the temperature based on a mathematical model that predicts the temperature of the battery pack 820. The sensed battery voltage, sensed battery current, and the determined battery temperature T are then provided to the processor 430. The processor 430 is configured to estimate the SoC and/or the pack ID 516 of the battery back 502 based on the sensed battery current I, the sensed battery voltage V, and the determined battery temperature T. Based on the SoC and/or pack ID 516, the controller 410 may determine an available runtime of the power tool 110. In some examples, the controller 410 may implement machine learning, such as via the ML module 526 to predict information regarding a probable runtime for the power tool 110 based on the SoC and the pack ID 516. The controller 410 then controls the power tool 110, e.g., the motor 324 or an LED 824, to draw an amount of current from the battery pack 820 required to meet the desired runtime, as described above.

In some implementations, the ML module 526 is retrieved from the memory 432 and executed using the processor 430. To implement one or more machine learning algorithms, the controller 410 is configured to learn a general rule or model that maps the inputs to the outputs based on the provided example input-output pairs. The machine learning algorithm may be configured to perform machine learning using various types of methods. For example, the controller 410 may implement the machine learning program using decision tree learning (such as random decision forests), associates rule learning, artificial neural networks, recurrent artificial neural networks, long short term memory neural networks, inductive logic programming, support vector machines, clustering, Bayesian networks, reinforcement learning, representation learning, similarity and metric learning, sparse dictionary learning, genetic algorithms, k-nearest neighbor (KNN), among others, such as those listed in Table 1 below.

TABLE 1

| | |
|---|---|
| Recurrent | Recurrent Neural Networks [“RNNs”], Long Short-Term Memory |
| Models | [“LSTM”] models, Gated Recurrent Unit [“GRU”] models, Markov |
| | Processes, Reinforcement learning |
| Non-Recurrent | Deep Neural Network [“DNN”], Convolutional Neural Network [“CNN”], |
| Models | Support Vector Machines [“SVM”], Anomaly detection (ex: Principle |
| | Component Analysis [“PCA”]), logistic regression, decision trees/forests, |
| | ensemble methods (combining models), polynomial/Bayesian/other |
| | regressions, Stochastic Gradient Descent [“SGD”], Linear Discriminant |
| | Analysis [“LDA”], Quadratic Discriminant Analysis [“QDA”], Nearest |
| | neighbors classifications/regression, naïve Bayes, attention networks, |
| | transformer networks, etc. |

The controller 410 is programmed and trained to perform a particular task using the machine learning algorithm. For example, in some implementations, the controller 410 is trained to determine whether the vacuum assembly 210 is actively vacuuming or is idle. The training examples used to train the machine learning algorithm may be graphs or tables of sensor data, vacuum mode, and whether the vacuum assembly 210 is actively vacuuming or idle. The training examples may be previously collected training examples, from, for example, a plurality of the same type of vacuums. For example, the training examples may have been previously collected from a plurality of vacuums of the same type (for example, the same make and model) over a span of, for example, one year.

A number of different training examples is provided to the controller 410. The controller 410 may use these training examples to generate a machine learning algorithm (e.g., a rule, a set of equations, and the like) that helps categorize the vacuum assembly 210 as actively vacuuming or idle based on new input data. The controller 410 may weight different training examples differently to, for example, prioritize different conditions or inputs and outputs to and from the controller 410. For example, certain observed operating characteristics may be weighed more heavily than others.

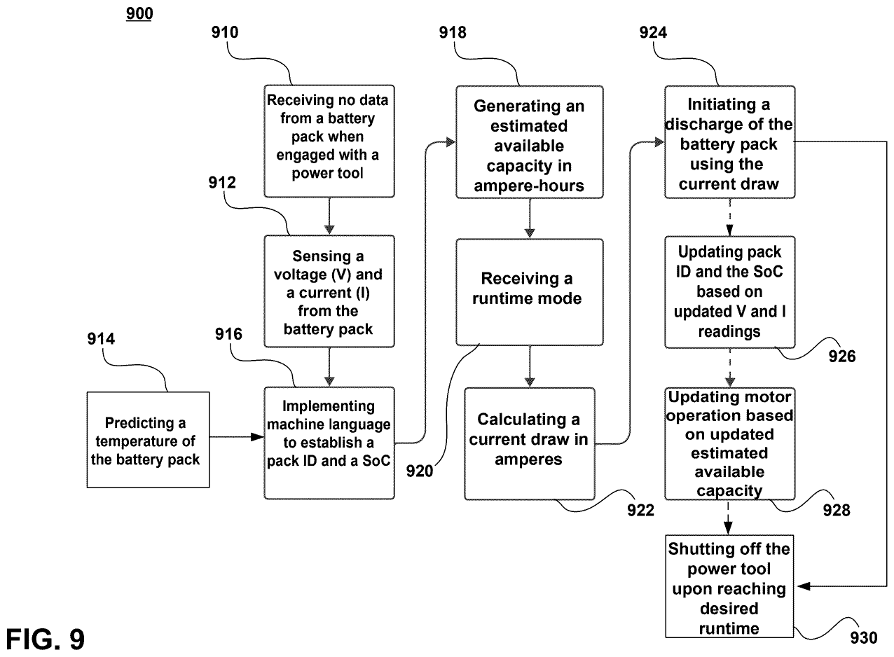

FIG. 9 is a flowchart illustrating a process 900 of implementing a desired runtime for the power tool 110 with the battery pack 802. The process 900 may be carried out by the controller 410.

At process block 910, the battery pack 820 is engaged with the power tool 110. The battery pack 802, as described above, does not transmit any additional data (e.g., SoC, SoH, DCIR, battery ID, etc.) to the controller 410. Receiving no data from a battery pack upon engagement with a power tool

At process block 912, the controller 410 senses initial measurements of V and I for the battery pack 802 via the current sensor 418C and the voltage sensor 418B.

At process block 914, the controller 410 calculates the battery temperature T of the battery pack 802. In one example, the controller 410 may utilize the PTM 528 to determine the battery temperature T of the battery pack 802.

At process block 916, the controller 410 calculates the SoC of the battery pack 820 based on at least the sensed battery voltage V, the sensed current I, and the determined battery temperature T. In some embodiments, the controller 410 may implement one or more machine learning algorithms to determine the SoC of the battery pack 820. In some embodiments, the controller 410 may be configured to determine other parameters of the battery pack 820, such as the DCIR, the SoH, and/or the pack ID of the battery pack 820, as required for a given application.

At process block 918, the controller 410 generates an estimated available capacity in ampere-hours (Ah) of the battery pack 820. In one embodiment the estimated available capacity of the battery pack 820 is determine based on the SoC of the battery pack 820. In other examples, additional parameters, such as the pack ID, SoH, and voltage V of the battery pack 820 may be used by the controller 410 may be used to determine the available capacity. In further examples, the controller 410 may use one or more machine learning algorithms to determine the available capacity of the battery pack 820.

At process block 920, the controller 410 receives, via the set of inputs 536, a runtime mode input associated with the desired runtime. The runtime mode provides a desired runtime of the power tool 110. For example, the runtime mode input may be received via the HMI 534.

At process block 922, the controller 410 calculates a required current draw in amperes (A) based on the estimated available capacity and the requested runtime mode 538. The required current draw may be the maximum current permitted to be drawn to achieve a desired runtime based on the received runtime mode input.

At process block 924, the controller 410 initiates operation of the power tool 110 at a level such that the consumed power is substantially equal to the required current draw associated with the desired runtime. For example, the controller 410 may control the switching network 416 to regulate the power provided to the motor 324.

In some examples, the controller 410 may track the runtime based solely on the initial estimated available capacity as described above. It is further contemplated that at block 926 the controller periodically updates the estimated available capacity. The updated estimated available capacity may be determined similarly to the estimated available capacity as described above.

At process block 928, the controller 410 updates the motor operation based on the updated estimated available capacity to ensure that the power tool 110 will meet the desired runtime.

At process block 930, the controller 410 determines that the desired runtime has been reached and stops operation of the power tool 110.

Although the disclosure has been described with reference to certain preferred aspects, variations and modifications exist within the scope and spirit of one or more independent aspects of the disclosure as described. Various features and advantages of the disclosure are set forth in the following claims.

What is claimed is:

1. A method of operating a power tool for a desired runtime, the method comprising:
determining, with a controller for the power tool, at least one parameter of a battery pack connected to the power tool;
generating, with the controller, an available capacity in ampere-hours based on the at least one parameter;
receiving, at the controller, a runtime mode associated with a desired runtime;
calculating, with the controller, a required current draw based on the available capacity and the runtime mode to achieve the desired runtime;
drawing an amount of current equal to the calculated required current draw to operate the power tool;
determining that the power tool has operated for the desired runtime; and
ceasing operation of the power tool in response to determining that the power tool has operated for the desired runtime.

2. The method of claim 1, further comprising collecting, with a set of sensors in communication with the controller, a set of variables, including a voltage and a current of the battery pack.

3. The method of claim 2, further comprising determining, with the set of sensors, a battery temperature of the battery pack.

4. The method of claim 2, further comprising predicting, with a pack thermal model (PTM) of the controller, a battery temperature of the battery pack.

5. The method of claim 4, wherein determining the at least one parameter of the battery pack further comprises calculating, at the controller, a state of charge (SoC) of the battery pack using a machine learning algorithm.

6. The method of claim 5, further comprising determining a pack ID of the battery pack based on the determined at least one parameter using a machine learning algorithm.

7. The method of claim 1, further comprising receiving, at the controller, one or more updated parameters of the battery pack and recalculating, with the controller, the current draw required to achieve the desired runtime based on the updated parameters of the battery pack.

8. The method of claim 7, further comprising updating operation of the power tool to operate at the recalculated current draw.

9. The method of claim 1, wherein estimating the at least one parameter comprises at least one selected from a list consisting of: a state of charge (SoC), a state of health (SoH), or a battery impedance (DCIR).

10. The method of claim 1, wherein the at least one parameter is provided by a battery pack controller of the battery pack.

11. The method of claim 1, further comprising operating a motor to draw the amount of current equal to the calculated required current drawn to operate the power tool.

12. A power tool, comprising:
a set of sensors configured to measure a set of variables associated with a battery pack coupled to the power tool, wherein the set of variables includes at least one of a current and a voltage of the battery pack;
a human machine interface configured to generate a runtime mode output, wherein the runtime mode output indicates a desired runtime of the power tool; and
a controller configured to determine at least one operating parameter for the battery pack based on the set of variables and adapt an amount of current drawn from the battery pack based on the desired runtime and the at least one operating parameter.

13. The power tool of claim 12, further comprising a motor.

14. The power tool of claim 12, wherein the set of variables further comprises a battery temperature of the battery pack.

15. The power tool of claim 12, wherein the controller comprises a pack thermal model (PTM) configured to determine a battery temperature of the battery pack based on a mathematical model.

16. The power tool of claim 13, wherein the at least one operating parameter comprises at least one selected from a list consisting of: a state of charge (SoC), a state of health (SoH), or a battery impedance (DCIR).

17. The power tool of claim 13, the controller is configured to determine a pack ID of the battery pack.

18. A power tool comprising:
a battery pack interface for engaging with a battery pack to power the power tool;
a set of sensors for measuring a set of variables associated with the battery pack; and
a controller, the controller configured to:
determine a state of charge of the battery pack based on the set of variables;
generate an available capacity in ampere-hours based on the state of charge;
receive a selected runtime mode associated with a desired runtime mode indicating a desired runtime;
calculate a required current draw in amperes based on the available capacity and the selected runtime mode; and
operate the power tool to draw an amount of current equal to the required current draw to achieve the desired runtime.

19. The power tool of claim 18, wherein the controller is configured to determine a state of health (SoH) or a battery impedance (DCIR) associated with the battery pack and based on the set of variables.

20. The power tool of claim 18, wherein the controller comprises a pack thermal model (PTM) configured to determine a battery temperature of the battery pack based on a mathematical model.
